(19) United States
(12) Patent Application Publication
(10) Pub. No.: US 2025/0344131 A1
(43) Pub. Date: Nov. 6, 2025

(54) SYSTEMS AND METHODS FOR WIFI MOTION SENSING WITH ADVANCED DEVICE LOCALIZATION

(71) Applicant: PLUME DESIGN, INC., Palo Alto, CA (US)

(72) Inventors: Ha DO, Cumming, GA (US); Jeffrey ChiFai LIEW, Millbrae, CA (US); Richard CHANG, Los Altos Hills, CA (US); Sean LI, Campbell, CA (US); Charles KRING, Sunnyvale, CA (US); Timothy NGUYEN, San Jose, CA (US)

(21) Appl. No.: 18/654,671

(22) Filed: May 3, 2024

(51) Int. Cl. H04W 48/04; H04W 12/73; H04W 12/76; H04W 64/00

(52) U.S. Cl. CPC H04W 48/04; H04W 12/76; H04W 64/006; H04W 12/73

(57) ABSTRACT

Disclosed are systems and methods that provide a decision-intelligence (DI)-based, computerized framework for advanced device naming and localization of Wi-Fi connected devices at a location. The disclosed framework operates to manage, control and/or manipulate devices on a Wi-Fi network, which provides intuitive mechanisms to select devices to name, group and/or locate in a WiFi app with WiFi motion and/or detected gesture(s) by leveraging voting and ranking mechanisms via a compiled cross-correlation matrix of channel frequency response (CFR) motion signatures and/or channel state information (CSI) motion signatures. Accordingly, motion signature information can be leveraged to control, enable and/or permit Wi-Fi connections among and/or between devices at a location.

### FIELD OF THE DISCLOSURE

The present disclosure is generally related to Wireless Fidelity (Wi-Fi or WiFi) networks and control thereof, and more particularly, to a decision intelligence (DI)-based computerized framework for deterministically performing advanced device localization, management and control of devices operating on a Wi-Fi network at a location.

### SUMMARY OF THE DISCLOSURE

According to some embodiments, the disclosed systems and methods provide a novel framework for managing, controlling and manipulating devices on a Wi-Fi network. According to some embodiments, as discussed herein, the disclosed systems and methods provide intuitive mechanisms to select devices to name, group and/or locate in a WiFi app with WiFi motion and/or detected gesture(s) by leveraging voting and ranking mechanisms via a compiled cross-correlation matrix of channel frequency response (CFR) motion signatures and/or channel state information (CSI) motion signatures.

CFR and CSI motion signatures refer to analyzed and extracted information from wireless channels (or bands-for example, 2.4 GHz and 5 GHZ), which corresponds to motion and/or movement in a given location. Both CFR and CSI can be used in the context of WiFi networks, particularly in scenarios where it is desirable to detect and monitor motion without the need for dedicated motion sensors.

According to some embodiments, CFR refers to the characteristics of the wireless channel at different frequencies. The characteristics of the wireless channel, including how signals propagate and interact with the environment, can vary across these frequencies. CFR involves measuring how a wireless channel responds to signals at various frequencies within the WiFi spectrum. CFR involves measuring the response of the wireless channel to a known input signal at various frequencies. This can be performed by transmitting a signal and then analyzing how it is received, taking into account any changes or distortions introduced by the channel.

Understanding CFR can be crucial for optimizing WiFi network performance. As discussed herein, CFR can aid in identifying frequency-dependent effects such as, but not limited to, signal attenuation, reflections and multipath interference. By analyzing CFR, the disclosed framework can make informed decisions about channel selection, antenna placement and overall network configuration to mitigate the impact of channel-specific challenges.

Moreover, WiFi routers and access points can automatically select a channel based on an assessment of the CFR to minimize interference and maximize performance. Thus, as discussed herein, dynamic channel selection, as well as dynamic frequency selection (DFS) can be performed within particular WiFi network environments.

According to some embodiments, CSI corresponds to a set of parameters that describe the current state of a communication channel. CSI includes information about, but not limited to, signal amplitude, phase and frequency response at various subcarriers and/or frequency components. For example, CSI can be particularly relevant in Multiple-Input Multiple-Output (MIMO) systems for optimizing communication performance. In another example, WiFi devices, such as routers and clients, can use CSI for various purposes, including beamforming, spatial multiplexing and improving overall communication performance.

According to some embodiments, as discussed herein, a motion signature refers to a unique pattern and/or set of changes in the CFR and/or CSI data that occurs when there is motion within the location. For example, when a person or object moves within the range of a WiFi network, variations in the wireless channel characteristics can be caused, which can be detected and analyzed to infer the presence and movement of objects. Thus, for example, as discussed herein, CFR/CSI motion signatures are applicable in various fields, including, but not limited to, WiFi sensing and management, home automation, healthcare, security and the like.

According to some embodiments, a cross-correlation matrix of CFR/CSI motion signatures, as discussed herein, can be configured as a data structure including information related to mathematical representations that describes a degree of similarity and/or correlation between different sets of motion signatures obtained from CFR and/or CSI data. Such matrix can be used in signal processing and communications to analyze the relationships between signals, in this case, to understand how similar or dissimilar motion patterns are across different channels or antennas.

According to some embodiments, the cross-correlation matrix can involve such components and concepts such as, but not limited to, cross-correlation, matrix representation and application execution and/or initiation (e.g., beamforming, motion detection, channel selection, and the like). For example, in some embodiments, cross-correlation is a measure of similarity between two signals as a function of a time lag applied to one of them. In the context of motion signatures derived from CFR or CSI, cross-correlation helps quantify how similar the motion patterns are across different channels, antennas and/or time instances.

In some embodiments, a cross-correlation matrix can be an n×m (e.g., square) matrix, where each element represents the cross-correlation between the motion signatures of two specific channels or antennas. For example, if there are N channels or antennas, the cross-correlation matrix will be an N×N matrix. In some embodiments, diagonal elements of the matrix (e.g., at positions [i, i]) can represent the self-correlation of each channel, showing how consistent the motion pattern is within a single channel. In some embodiments, off-diagonal elements (e.g., at positions [i, j], where i≠j) can represent the cross-correlation between motion patterns of different channels. For example, higher values indicate higher similarity in motion patterns between those channels.

According to some embodiments, a high cross-correlation value (e.g., at or above a cross-correlation threshold) can indicate that the motion signatures in the corresponding channels are similar, indicating/predicting that the motion is likely occurring in a coordinated manner across those channels. In some embodiments, alternatively, low cross-correlation values (e.g., below the cross-correlation threshold) can indicate a dissimilarity in motion patterns.

Thus, according to some embodiments, as discussed herein, the disclosed computerized framework provides functionality for advanced device naming and localization of Wi-Fi connected devices at a location (e.g., home, office, and/or any other geographic/physical location for which a network can be accessible). As discussed herein, the disclosed framework operates to select devices to name, group and/or locate in a WiFi app with WiFi motion and/or detected gesture(s) based on a compiled cross-correlation matrix of CFR motion signature data and/or CSI motion signature data. Accordingly, motion signature data can be leveraged to control, enable and/or permit Wi-Fi connections among and/or between devices at a location.

According to some embodiments, a method is disclosed for a DI-based computerized framework for DSPs to deterministically perform advanced device localization, management and control of devices operating on a Wi-Fi network at a location. In accordance with some embodiments, the present disclosure provides a non-transitory computer-readable storage medium for carrying out the above-mentioned technical steps of the framework's functionality. The non- transitory computer-readable storage medium has tangibly stored thereon, or tangibly encoded thereon, computer readable instructions that when executed by a device cause at least one processor to perform a method for deterministically performing advanced device localization, management and control of devices operating on a Wi-Fi network at a location.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a block diagram of an example configuration within which the systems and methods disclosed herein could be implemented according to some embodiments of the present disclosure;

FIG. 2 is a block diagram illustrating components of an exemplary system according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure, a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub- networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

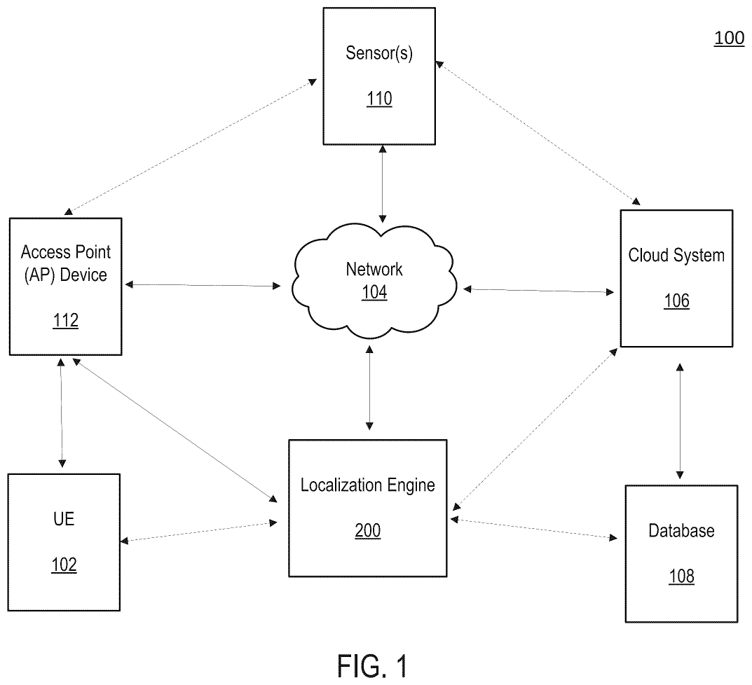

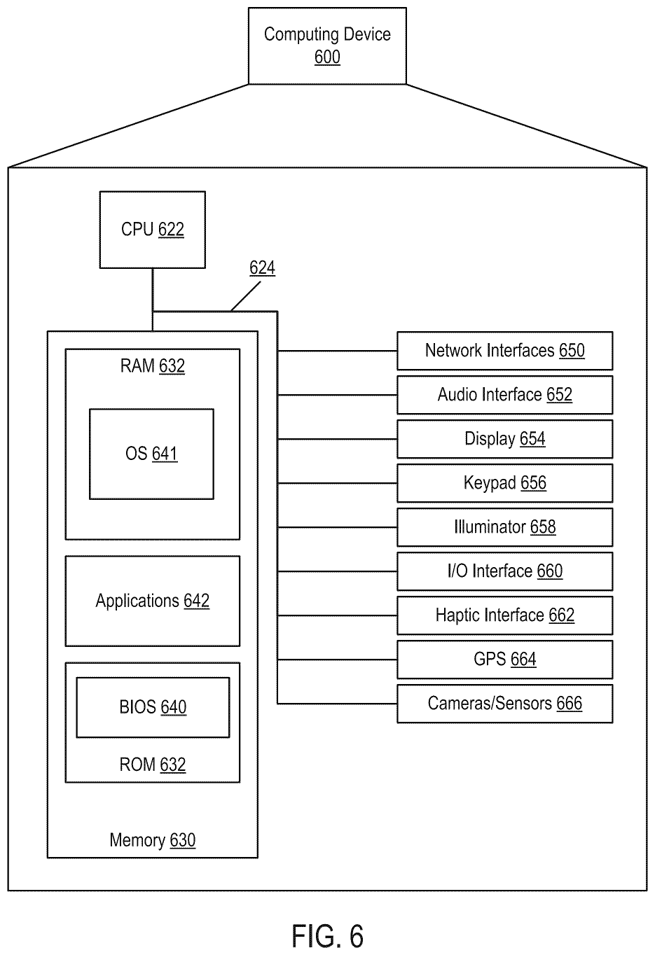

Certain embodiments and principles will be discussed in more detail with reference to the figures. With reference to FIG. 1, system 100 is depicted which includes user equipment (UE) 102 (e.g., a client device, as mentioned above and discussed below in relation to FIG. 6), AP device 112, network 104, cloud system 106, database 108, sensors 110 and localization engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1.

According to some embodiments, UE 102 can be any type of device, such as, but not limited to, a mobile phone, tablet, laptop, sensor, IoT device, wearable device, autonomous machine, smart television, media streaming device, game console, and any other device equipped with a cellular or wireless or wired transceiver.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

According to some embodiments, sensors 110 can correspond to any type of device, component and/or sensor associated with a location of system 100 (referred to, collectively, as “sensors”). In some embodiments, the sensors 110 can be any type of device that is capable of sensing and capturing data/metadata related to activity of the location. For example, the sensors 110 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. For example, the sensors 110 can include the sensors on UE 102 (e.g., smart phone) and/or peripheral device (e.g., a paired smart ring). In some embodiments, sensors 110 can be associated with any device connected and/or operating on cloud system 106 (e.g., a cloud-based device, such as a server that collects information related to the location, for example).

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider (e.g., Plume Design®), which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, sensors 110, and the services and applications provided by cloud system 106 and/or localization engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

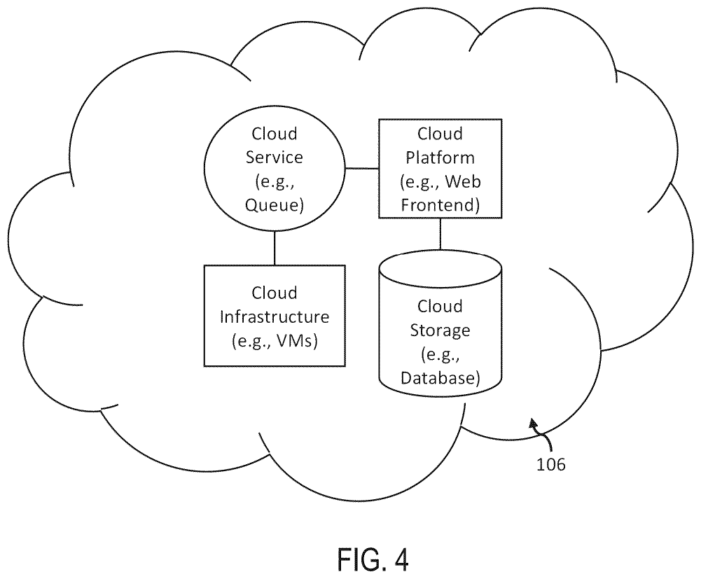

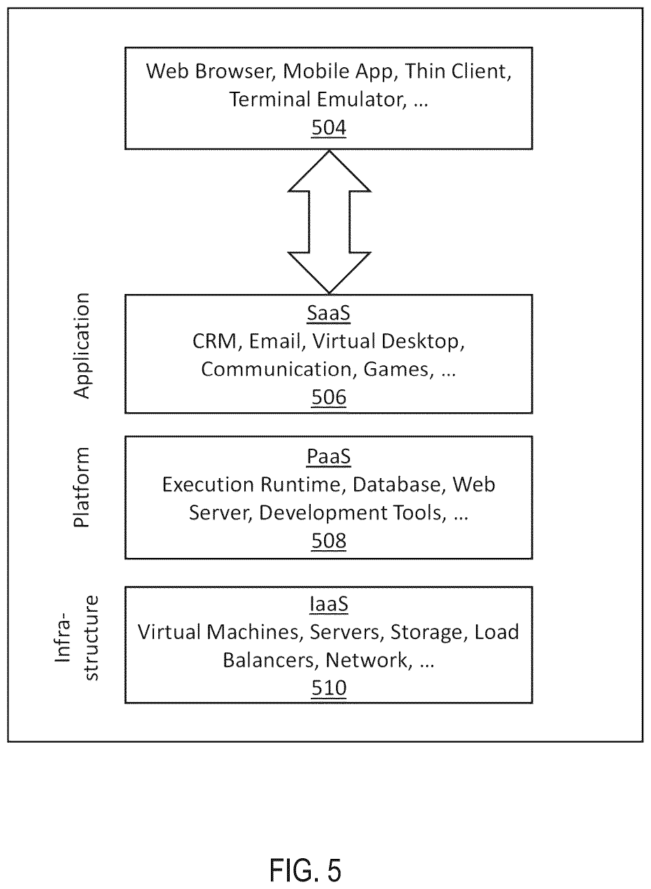

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Localization engine 200, as discussed above and further below in more detail, can include components for the disclosed functionality. According to some embodiments, localization engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, as discussed in more detail below, localization engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, localization engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112 and/or UE 102 (and/or sensors 110). In some embodiments, such application may be a web-based application accessed by AP device 112 and/or UE 102, and/or devices associated with sensors 110 over network 104 from cloud system 106. In some embodiments, engine 200 may be configured and/or installed as an augmenting script, program or application (e.g., a plug-in or extension) to another application or program provided by cloud system 106 and/or executing on AP device 112, UE 102 and/or sensors 110.

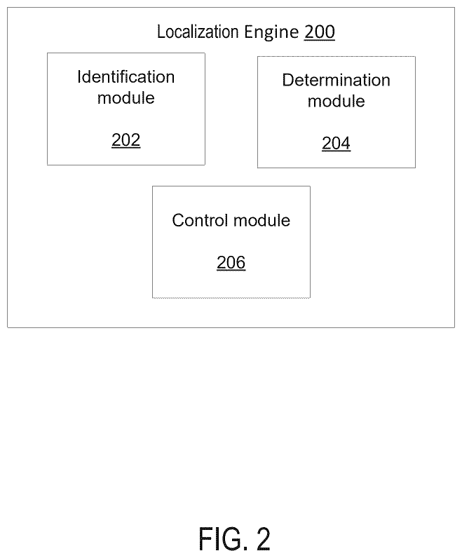

As illustrated in FIG. 2, according to some embodiments, localization engine 200 includes identification module 202, determination module 204 and control module 206. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

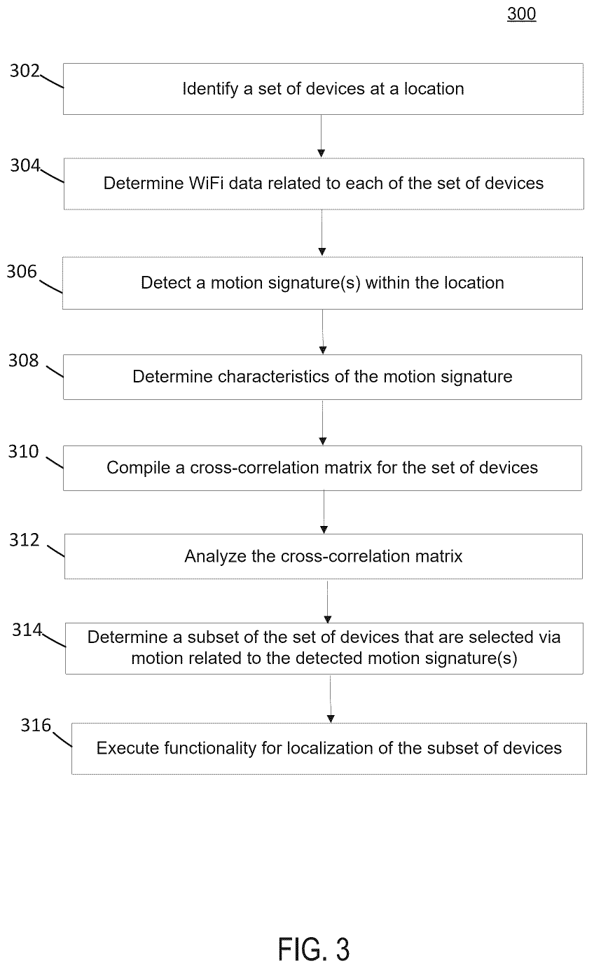

Turning to FIG. 3, Process 300 provides non-limiting example embodiments for the disclosed localization and device naming functionality. As provided below, the disclosed framework's configuration and implementation can provide a computerized suite of localization tools for managing (e.g., selecting, naming and/or grouping) devices and/or Wi-Fi network activity by such devices at a location (e.g., home, office and/or other physical locations for which a computerized network is provided).

According to some embodiments, the disclosed framework enables the selection of and performance of, but not limited to, device naming, grouping, timeout scheduling, localizing, WiFi name and password assignment, and the like. Conventional mechanisms require users to perform such tasks on an individualized basis, and do not provide mechanisms for selectively identifying such devices (e.g., especially when similar devices (e.g., multiples of the same device model/version) are co-located at a location.

Accordingly, in some embodiments, the disclosed framework can operate to leverage WiFi sensing with WiFi motion functionality to locate specific devices (e.g., single and/or multiple devices) at a time to select for localization. By way of a non-limiting example, by performing/making a gesture movement (or moving (e.g., walking), in some embodiments) in proximity to a device (or holding and shaking the device, in some embodiments), the disclosed framework can initiate and execute WiFi sensing functionality which can initiate a pop-up displaying that device for localization (e.g., naming, grouping, locating, scheduling timeout, freezing, and the like, or some combination thereof). For example, this can aid in identifying devices that have mistyped or misnamed identifiers (IDs), as well as distinguishing between devices that are the same model. According to some embodiments, as provided below, a gesture/movement in relation to a position or sub-location of a location (e.g., room of a house) can enable the devices positioned in that sub-location to be selected and grouped (e.g., group all the smart devices in the kitchen).

As provided below, location featuring of a device and/or group of devices at a location (e.g., via CFR, CSI and/or line of sight WiFi signal paths, and the like), can be determined, learned and leveraged for the performance of WiFi sensing technologies deployed by the disclosed framework, which can improve how the framework can selectively identify devices amongst a group of devices at a location.

According to some embodiments, Step 302 of Process 300 can be performed by identification module 202 of localization engine 200; Steps 304-314 can be performed by determination module 204; and Step 316 can be performed by control module 206.

According to some embodiments, Process 300 begins with Step 302 where engine 200 can identify a set of devices at a location. According to some embodiments, the set of devices can be related to each device at a location and/or a portion of the devices at a location. For example, devices within a room or sub-portion of a location (e.g., in the living room of a home, for example). In some embodiments, identification of the devices can be based on whether a user (or other living thing, for example, a pet) in/at the location (e.g., whereby such determination can be effectuated via the performance of WiFi sensing.

According to some embodiments, Step 302 can involve a user providing a gesture (e.g., waving their hand in the direction of a device(s) at a location, for which, via WiFi sensing functionality, the device can detection the motion, and the processing of Process 300 can commence, as discussed herein.

Accordingly, according to some embodiments, the identification of the devices can involve engine 200 performing WiFi sensing functionality. WiFi sensing (or RF sensing) involves mechanisms that leverage WiFi signals that can be affected by physical objects (e.g., moving objects). Such sensing can involve signal reflection and absorption, when a Wi-Fi signal is transmitted, it travels through the air, and its waves can interact with objects in its path (e.g., solid objects, like walls and furniture, can reflect and absorb Wi-Fi signals to varying degrees). A Doppler effect can be utilized, whereby the movement of an object can cause a shift in the frequency of the Wi-Fi signal (e.g., this frequency shift is detected by analyzing changes in the wireless signal). Signal processing can be utilized for WiFi sensing, whereby engine 200 can continuously analyze (e.g., according to a time period) the received Wi-Fi signals, and the determined/detected changes in signal patterns can be interpreted as motion (e.g., known or to be known types of artificial intelligence/machine learning (AI/ML) algorithms can be applied to process the variations in signal strength, phase, and frequency caused by the movement of objects). Additionally, WiFi sensing can involve device localization, whereby multiple Wi-Fi access points at a location can be used to triangulate the position of the moving object (e.g., the relative changes in signal strength at different access points can be utilized to estimate the position of the object within the Wi-Fi-covered area).

Thus, in Step 304, engine 200 can determine WiFi data for each of the identified set of devices (from Step 302). In some embodiments, such WiFi data can include, but is not limited to, CFR data and CSI data (as discussed above), signal strength, signal phase, signal frequency, time- of-flight (ToF), localization information (e.g., triangularization, as discussed above), data processing outputs (e.g., analytical outputs, such as, for example, processed data that can include information related to speed, direction and trajectory of motion of devices and/or detected objects), and the like, or some combination thereof.

In Step 306, engine 200 can perform computational analysis on the WiFi data for each device, whereby, as discussed herein, CFR and/or CSI motion signatures can be extracted from the corresponding WiFi data for a device in the identified set of devices. According to some embodiments, Step 304 can involve engine 200 analyzing the WiFi data for each device which can involve engine 200 executing a specific trained AI/ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more AI/ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U- net) or other suitable network. In some embodiments and, optionally, in combination of any embodiment described above or below, an implementation of Neural Network may be executed as follows:
a. define Neural Network architecture/model,
b. transfer the input data to the neural network model,
c. train the model incrementally,
d. determine the accuracy for a specific number of timesteps,
e. apply the trained model to process the newly received input data,
f. optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Thus, based on the analysis of the WiFi data, in Step 306, engine 200 can determine the CFR and/or CSI motion signatures for each device and their corresponding WiFi signals being communicated, transmitted and/or received within the location. In some embodiments, such WiFi data and the CFR and/or CSI motion signatures for a device can be stored in database 108, as discussed above.

In Step 308, engine 200 can determine characteristics of the determined CFR and/or CSI motion signatures for each device. A motion signature refers to the unique patterns or characteristics associated with the movement of an object. In the context of motion detection using technologies like radar, sonar, or even Wi-Fi sensing, a motion signature typically includes various features that can be analyzed to identify and characterize motion. In some embodiments, motion signature characteristics can involve, but are not limited to, frequency, amplitude, direction, duration, acceleration and deceleration, shape and pattern, spatial characteristics, doppler shift (if applicable), energy distribution, biometric signatures (e.g., for human motion, features such as walking gait, for example), and the like.

In Step 310, engine 200 can leverage the CFR and/or CSI motion signatures, as well as the motion signature characteristics, and determine a CFR/CSI cross-correlation matrix. As discussed above, the CFR/CSI cross-correlation matrix, embodied as a data structure (or file), is a representation of how CFR and CSI data (e.g., CFR motion signatures and the CFR motion signature characteristics, and the CSI motion signatures and the CSI motion signature characteristics) are correlated or related to each other. As discussed above, such cross-correlation between CFR and CSI can be used in Wi-Fi sensing applications for various purposes, including motion detection and localization. Accordingly, changes in the cross-correlation matrix can be indicative of environmental changes, movement, and/or interference within the Wi-Fi coverage area.

According to some embodiments, in motion detection systems that utilize Wi-Fi signals, the cross-correlation matrix between CFR and CSI can be analyzed to identify patterns associated with motion. As objects move within a Wi-Fi coverage area, they can cause changes in both CFR and CSI, and the cross-correlation matrix can be leveraged to determine how such changes correlate. Moreover, the cross-correlation matrix can also be used in localization and tracking systems-by comparing CFR and CSI data from multiple access points, engine 200 can determine the location and movement of Wi-Fi-enabled devices.

Thus, in Step 312, engine 200 can analyze the cross-correlation matrix. In some embodiments, engine 200 can utilize any of the AI/ML techniques discussed above to perform the analysis. In some embodiments, engine 200 can parse the matrix data structure, and determine whether any of the information related to a subset of devices are identifiable based on their CFR/CSI data included in the matrix, as discussed above.

Accordingly, in Step 314, engine 200 can determine a subset of a set of the devices based on the analysis. The subset includes devices that are at least one of within a predetermined distance to a user (e.g., within 5 feet, for example, or a closest device, for example) and within a line of sight of the user (e.g., line of sight of the gesture from Step 302). The subset, which can include one device or more (but less than or equal to a total of the set of devices) can be devices for which localization can be performed (as per Step 316, discussed infra).

In some embodiments, such determination can involve engine 200 executing at least one of a voting methodology and a ranking methodology, via the cross-correlation matrix. For example, correlation patterns from the matrix can be analyzed and/or mined, and a voting method/algorithm can then be applied to combine these patterns to derive a consolidated determination. For example, if different algorithms agree on the presence of a certain pattern in the matrix, such pattern, upon satisfaction of a threshold, can be viewed as a result of a position of a device at the location.

In another example, a ranking method can involve assessing the significance and/or strength of correlations between different values and/or characteristics within the matrix. For example, higher-ranked correlations (e.g., above a threshold) may be considered more influential or indicative of specific patterns. In some embodiments, this can enable engine 200 to prioritize certain devices over other devices (e.g., device 1 is located closer to the user/user's gesture than device 2).

And, in Step 316, engine 200 can execute functionality for localization of the subset of devices. Such functionality can involve a display, user interface (UI) or other type of pop-up window that enables the identification of each subset device, and the localization thereof (e.g., selection, naming, freezing, pairing, naming, connecting, and the like). Thus, localization actions can cause and/or enable modified control of how each device in the subset is capable of being identified and operated on the WiFi network.

In some embodiments, engine 200 can determine that the subset of devices are related to a similar position within the location (e.g., in the same room). In some embodiments, the grouping can be based on a common parameter for the subset (e.g., type of device, position in the location (e.g., on a desk, on the wall, and the like), which device is the user associated with (e.g., user 1's smart phone and tablet versus user 2's smart watch, for example), and the like, or some combination thereof. Therefore, in some embodiments, engine 200 can group such devices with a naming convention based on such similar parameter, whereby localization for the group can be performed at the group level (e.g., freeze each device in the “living room” group when no users are in that room, which can save energy and/or network resources while such devices are not in use or not needed).

In some embodiments, the collected/determined WiFi data, motion signatures, characteristics, matrix values, and the like, can be stored in database 108, and utilized to train the AI/ML models used by engine 200 for subsequent device naming/localization iterations, which can be for the same set of devices and/or network, and/or different devices and/or networks.

By way of a non-limiting example, according to some embodiments, user Jane enters her home office, which has 3 devices: her smart phone (on the desk), a smart TV on the wall across the room from the desk, and son Tim's smart phone (also on the desk). Jane and Tim have the same model phone. Jane waves her arm in the direction of the desk (e.g., each device has line of sight to the gesture), and as discussed above, the data for Jane's phone and Tim's phone. After analyzing the cross-correlation matrix compiled for each device, Jane's phone and Tim's phone can be differentiated, whereby their positions respective to the wave can be leveraged to separately identify each device, for which localization can be performed (e.g., device naming, and the like).

Thus, the disclosed systems and methods provide an intuitive way for users to select devices to name, group and/or locate by using movements or gestures. By detecting motion and coordinating it between device channels, WiFi sensing can localize the devices and select devices that are close to the motion and/or have light-of-sight to the motion location.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi- core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
identifying a set of devices at a location, the set of devices being devices connected to a Wi-Fi network at the location;
determining, for each of the set of devices, WiFi data;
analyzing the WiFi data, and determining a set of motion signatures for each device;
determining, based on the set of motion signatures for each device, a cross-correlation matrix, the cross-correlation matrix configured as a data structuring storing information related to each of the set of motion signatures;
determining, based on the cross-correlation matrix, a subset of the set of devices, the subset of devices corresponding to devices being at least one of within a predetermined distance to a user and within a line of sight of the user; and
executing, for each of the subset of devices, localization actions on the WiFi network, the localization actions enabling modified control of how each device in the subset is capable of being identified and operated on the WiFi network.

2. The method of claim 1, wherein localization comprises performing at least one of device selection, device naming, grouping, timeout scheduling, localizing, and WiFi name and password assignment.

3. The method of claim 1, further comprising:
grouping the subset of devices according to a common parameter; and
performing localization for the group via the grouping.

4. The method of claim 1, wherein the WiFi data comprises channel frequency response (CFR) data and channel state information (CSI) data.

5. The method claim 4, wherein the set of motion signatures comprises a CFR motion signature and a CSI motion signature.

6. The method of claim 1, further comprising:
analyzing the set of motion signatures; and
determining characteristics of the motion signatures, wherein the cross-correlation matrix is further based on the determined characteristics.

7. The method of claim 6, wherein the characteristics comprise information related to at least one of frequency, amplitude, direction, duration, acceleration and deceleration, shape and pattern, spatial characteristics, doppler shift, energy distribution and biometric signatures.

8. The method of claim 1, further comprising:
detecting, from a user, movement corresponding to at least one of a gesture or the user moving within the location, wherein the detection is based on the performing of WiFi sensing functionality, wherein identification of the set of devices is based on the detected movement.

9. A system comprising:
a processor configured to:
identify a set of devices at a location, the set of devices being devices connected to a Wi-Fi network at the location;
determine, for each of the set of devices, WiFi data;
analyze the WiFi data, and determine a set of motion signatures for each device;
determine, based on the set of motion signatures for each device, a cross-correlation matrix, the cross-correlation matrix configured as a data structuring storing information related to each of the set of motion signatures;
determine, based on the cross-correlation matrix, a subset of the set of devices, the subset of devices corresponding to devices being at least one of within a predetermined distance to a user and within a line of sight of the user; and
execute, for each of the subset of devices, localization actions on the WiFi network, the localization actions enabling modified control of how each device in the subset is capable of being identified and operated on the WiFi network.

10. The system of claim 9, wherein localization comprises performing at least one of device selection, device naming, grouping, timeout scheduling, localizing, and WiFi name and password assignment.

11. The system of claim 9, wherein the processor is further configured to:
group the subset of devices according to a common parameter; and
perform localization for the group via the grouping.

12. The system of claim 9, wherein the WiFi data comprises channel frequency response (CFR) data and channel state information (CSI) data, wherein the set of motion signatures comprises a CFR motion signature and a CSI motion signature.

13. The system of claim 9, wherein the processor is further configured to:
analyze the set of motion signatures; and
determine characteristics of the motion signatures, wherein the cross-correlation matrix is further based on the determined characteristics.

14. The system of claim 9, wherein the processor is further configured to:
detect, from a user, movement corresponding to at least one of a gesture or the user moving within the location, wherein the detection is based on the performing of WiFi sensing functionality, wherein identification of the set of devices is based on the detected movement.

15. A non-transitory computer-readable storage medium tangibly encoded with computer-executable instructions that when executed by a device, perform a method comprising:
identifying a set of devices at a location, the set of devices being devices connected to a Wi-Fi network at the location;
determining, for each of the set of devices, WiFi data;
analyzing the WiFi data, and determining a set of motion signatures for each device;
determining, based on the set of motion signatures for each device, a cross-correlation matrix, the cross-correlation matrix configured as a data structuring storing information related to each of the set of motion signatures;
determining, based on the cross-correlation matrix, a subset of the set of devices, the subset of devices corresponding to devices being at least one of within a predetermined distance to a user and within a line of sight of the user; and
executing, for each of the subset of devices, localization actions on the WiFi network, the localization actions enabling modified control of how each device in the subset is capable of being identified and operated on the WiFi network.

16. The non-transitory computer-readable storage medium of claim 15, wherein localization comprises performing at least one of device selection, device naming, grouping, timeout scheduling, localizing, and WiFi name and password assignment.

17. The non-transitory computer-readable storage medium of claim 15, further comprising:
grouping the subset of devices according to a common parameter; and
performing localization for the group via the grouping.

18. The non-transitory computer-readable storage medium of claim 15, wherein the WiFi data comprises channel frequency response (CFR) data and channel state information (CSI) data, wherein the set of motion signatures comprises a CFR motion signature and a CSI motion signature.

19. The non-transitory computer-readable storage medium of claim 15, further comprising:
analyzing the set of motion signatures; and
determining characteristics of the motion signatures, wherein the cross-correlation matrix is further based on the determined characteristics.

20. The non-transitory computer-readable storage medium of claim 15, further comprising:
detecting, from a user, movement corresponding to at least one of a gesture or the user moving within the location, wherein the detection is based on the performing of WiFi sensing functionality, wherein identification of the set of devices is based on the detected movement.
